(19) United States
(12) Patent Application Publication
(10) Pub. No.: US 2026/0038881 A1
(43) Pub. Date: Feb. 5, 2026

(54) Electrolyte Additive for Lithium Metal Batteries (LMBs) with Single Crystal Cathode

(71) Applicant: GM Global Technology Operations LLC, Detroit, MI (US)

(72) Inventors: Meinan He, Birmingham, MI (US); Anne M. Dailly, West Bloomfield, MI (US); Hanho Yun, Oakland Township, MI (US); Hasnain Hafiz, Troy, MI (US); Robert Steven Conell, Sterling Heights, MI (US)

(21) Appl. No.: 18/788,748

(22) Filed: Jul. 30, 2024

(51) Int. Cl. H01M 10/0569; H01M 4/02; H01M 4/38; H01M 4/505; H01M 4/525; H01M 10/0567; H01M 10/0568

(52) U.S. Cl. CPC H01M 10/0569; H01M 4/382; H01M 4/505; H01M 4/525; H01M 10/0567; H01M 10/0568; H01M 2004/027; H01M 2004/028; H01M 2220/20; H01M 2300/0034

(57) ABSTRACT

An electrolyte for a battery cell, a battery cell including the electrolyte, and a method of forming an electrolyte. The electrolyte includes a non-aqueous organic solvent including one or more solvents selected from the group consisting of a cyclic carbonate, a linear carbonate, an aliphatic carboxylic ester, a linear chain ester, and a cyclic ether. The electrolyte also includes a lithium salt, wherein the lithium salt is present in the non-aqueous organic solvent in the range of 1 M to 4 M. The electrolyte further includes a borate based additive, wherein the borate based additive, wherein the borate based additive is present in the range of 0.25 percent by weight to 5 percent by weight of the total weight of the electrolyte.

### BACKGROUND

Electric and hybrid electric vehicle technology is enabled by the development and deployment of rechargeable, secondary batteries, which provide energy to the vehicle powertrain. Secondary batteries include lithium ion batteries, which generally include a cathode, anode, separator, and electrolyte. The cathode provides the source of lithium ions and determines the capacity and average voltage of a battery. The anode stores and releases lithium ions received from the cathode when energy is needed, the separator prevents the cathode and anode from contacting and shorting out the battery, and the electrolyte provides a medium between the cathode and anode through which the lithium ions travel.

Battery performance may be quantified by a number of properties including energy density, power density, specific energy, specific power, charge rate, discharge rate, capacity decay, cycle life, thermal performance, and aging. To improve these metrics of battery performance and others, the materials used to form the cathode, anode, separator, and electrolytes and how those materials are formed have been the subject of numerous development efforts. Included in the development efforts is exploration of single crystal cathodes, as opposed to polycrystalline cathodes, which are commonly used in lithium ion battery applications. Single crystal cathodes exhibit an ordered structure of the various metals and oxides forming the cathode. Polycrystalline cathodes include nano-sized particles of oxides of the different transition metals (e.g., nickel, manganese, and cobalt) and lithium that are agglomerated together. Polycrystalline cathodes exhibit relatively good cycle life, retaining capacity up to about 500 cycles. However, polycrystalline cathodes exhibit some drawbacks in thermal performance and other factors. Single crystal cathodes have been found to exhibit relatively improved mechanical stability, thermal stability, and electrochemical stability. However, in replacing polycrystalline cathodes with single crystal cathodes, the single crystal cathodes have been found to exhibit relatively sluggish kinetics, impedance build-up, and an increased rate of capacity decay as compared to polycrystalline cathodes.

Thus, while present polycrystalline cathode chemistries and current single crystal cathodes achieve their intended purpose in particular applications, there is a need for new and improved single crystal cathode chemistries that offer relatively improved mechanical stability, thermal stability, and electrochemical stability as well kinetics, impedance, and capacity decay exhibited by polycrystalline cathodes.

### SUMMARY

According to various aspects, the present disclosure relates to an electrolyte for a battery cell. The electrolyte includes a non-aqueous organic solvent including one or more solvents selected from the group consisting of a cyclic carbonate, a linear carbonate, an aliphatic carboxylic ester, a linear chain ester, and a cyclic ether. The electrolyte also includes a lithium salt, wherein the lithium salt is present in the non-aqueous organic solvent in the range of 1 M to 4 M. The electrolyte further includes a borate based additive, wherein the borate based additive includes at least one compound selected from the group consisting of: trimethyl borate, tris(trimethyl silyl borate), triethyl borate, tris(2,2,2-trifluorethyl)borate, triisopropyl borate, tris(2-cyanoethyl)borate, triphenyl borate, Li[B(OCH₂)ₓ(CF₃)₄] wherein x is in the range of 1 to 6, lithium bis(oxalato)borate, lithium difluorooxalatoborate, and a compound represented by the following formula:

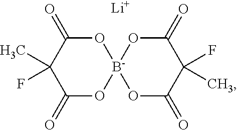 [SMILES: [Li+] ; CC1(F)C(=O)O[B-]2(OC1=O)OC(=O)C(C)(F)C(=O)O2]

and the borate based additive is present in the range of 0.25 percent by weight to 5 percent by weight of the total weight of the electrolyte.

In embodiments of the above, the non-aqueous organic solvent exhibits the following formula CₓH_{y}F_{w}O_{z}, wherein x is in the range of 3 to 6, y is in the range of 3 to 14, w is one of 0 and 1, and z is in the range of 1 to 3 and exhibits a molar mass in the range of 60 grams per mole to 120 grams per mole. In further embodiments, the non-aqueous organic solvent includes one or more solvents selected from the group consisting of: ethylene carbonate (EC), propylene carbonate (PC), butylene carbonate (BC), fluoroethylene carbonate (FEC), dimethyl carbonate (DMC), diethyl carbonate (DEC), ethylmethylcarbonate (EMC), methyl formate, methyl acetate, methyl propionate, g-butyrolactone, g-valerolactone, 1,2-dimethoxyethane, 1-2-diethoxyethane, ethoxymethoxy ethane, tetrahydrofuran, 2-methyltetrahydrofuran, and 1,3-dioxolane.

In any of the above embodiments, the lithium salt includes one or more lithium salts selected from the group consisting of: lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and lithium bis(trifluoromethanesulfonyl)azanide (LiTFSA).

In embodiments of the above, the non-aqueous organic solvent includes fluoroethylene carbonate and dimethyl carbonate, wherein the fluoroethylene carbonate is present in the range of 10 percent by weight to 90 percent by weight of the total weight of the non-aqueous organic solvent and the dimethyl carbonate is present in the range of 10 percent by weight to 90 percent by weight of the total weight of the non-aqueous organic solvent. In further embodiments, the lithium salt includes one or more of lithium hexafluorophosphate and lithium bis(fluorosulfonyl)imide. In yet further embodiments, the borate based additive is Li[B(OCH₂)ₓ(CF₃)₄] wherein x is in the range of 1 to 6. In alternative embodiments, the borate based additive is lithium bis(oxalato)borate. In further alternative embodiments, the borate based additive is lithium difluorooxalatoborate. In yet further alternative embodiments, the borate based additive is a compound represented by the following formula:

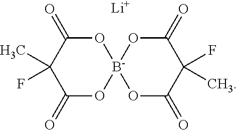 [SMILES: [Li+] ; CC1(F)C(=O)O[B-]2(OC1=O)OC(=O)C(C)(F)C(=O)O2]

According to various additional aspects, the present disclosure relates to a battery cell for use in a vehicle battery. The battery cell includes a cathode disposed on a cathode current collector, an anode disposed on an anode current collector, a separator positioned between the cathode and the anode, and an electrolyte contacting the cathode, anode, and separator. The electrolyte includes an electrolyte according to any of the above embodiments. In embodiments, the electrolyte includes a non-aqueous organic solvent including one or more solvents selected from the group consisting of a cyclic carbonate, a linear carbonate, an aliphatic carboxylic ester, a linear chain ester, and a cyclic ether. The electrolyte also includes a lithium salt, wherein the lithium salt is present in the non-aqueous organic solvent in the range of 1 M to 4 M. The electrolyte further includes a borate based additive, wherein the borate based additive includes at least one compound selected from the group consisting of: trimethyl borate, tris(trimethyl silyl borate), triethyl borate, tris(2,2,2-trifluorethyl)borate, triisopropyl borate, tris(2-cyanoethyl)borate, triphenyl borate, Li[B(OCH₂)ₓ(CF₃)₄] wherein x is in the range of 1 to 6, lithium bis(oxalato)borate, lithium difluorooxalatoborate, and a compound represented by the following formula:

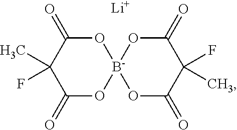 [SMILES: [Li+] ; CC1(F)C(=O)O[B-]2(OC1=O)OC(=O)C(C)(F)C(=O)O2]

and the borate based additive is present in the range of 0.25 percent by weight to 5 percent by weight of the total weight of the electrolyte.

In embodiments of the above, the anode includes one or more materials selected from the group consisting of: lithium silicon alloy, lithium aluminum alloy, lithium indium alloy, lithium titanate, lithium tin alloy, graphite, activated carbon, carbon black, graphene, silicon, silicon based alloys, silicon oxide, silicon based composite materials, tin oxide, aluminum, indium, zinc, germanium, and titanium oxide.

In any of the above embodiments, the cathode includes at least one material selected from the group consisting of: lithium iron phosphate, lithium manganese iron phosphate, lithium cobalt oxide, lithium nickel manganese oxides, lithium nickel manganese cobalt oxides, lithium nickel cobalt aluminum oxides, and lithium nickel cobalt manganese aluminum oxide. In further embodiments, the cathode includes lithium nickel manganese cobalt oxides having the formula LiNiₐMn_{b}Co_{c}AL_{d}O₂, wherein the sum of a, b, c, and d is 1.

In any of the above embodiments, the cathode includes one or more single crystals, wherein each single crystal is in the range of 5 percent by weight to 95 percent by weight of the total weight of the cathode. In further embodiments, each single crystal is in the range of 20 percent by weight to 50 percent by weight of the total weight of the cathode.

In any of the above embodiments, the anode includes lithium.

In further embodiments, the non-aqueous organic solvent includes fluoroethylene carbonate and dimethyl carbonate, wherein the fluoroethylene carbonate is present in the range of 10 percent by weight to 90 percent by weight of the total weight of the non-aqueous organic solvent and the dimethyl carbonate is present in the range of 10 percent by weight to 90 percent by weight of the total weight of the non-aqueous organic solvent; and the lithium salt includes one or more of lithium hexafluorophosphate and lithium bis(fluorosulfonyl)imide. In additional further embodiments, the borate based additive includes at least one compound selected from the following group of compounds: Li[B(OCH₂)ₓ(CF₃)₄] wherein x is in the range of 1 to 6, lithium bis(oxalato)borate, lithium difluorooxalatoborate, and a compound represented by the following formula:

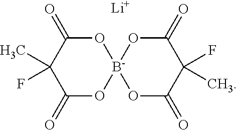 [SMILES: [Li+] ; CC1(F)C(=O)O[B-]2(OC1=O)OC(=O)C(C)(F)C(=O)O2]

According to various further aspects, the present disclosure relates to a method of forming an electrolyte. The method includes mixing a non-aqueous organic solvent, a lithium salt, and a borate based additive, wherein the non-aqueous organic solvent includes one or more non-aqueous organic solvents selected from the group consisting of a cyclic carbonate, a linear carbonate, an aliphatic carboxylic ester, a linear chain ester, and a cyclic ether, wherein the lithium salt is present in the non-aqueous organic solvent in the range of 1 M to 4 M, wherein the borate based additive includes at least one compound selected from the following group of compounds: trimethyl borate, tris(trimethyl silyl borate), triethyl borate, tris(2,2,2-trifluorethyl)borate, triisopropyl borate, tris(2-cyanoethyl)borate, triphenyl borate, Li[B(OCH₂)ₓ(CF₃)₄] wherein x is in the range of 1 to 6, lithium bis(oxalato)borate, lithium difluorooxalatoborate, and a compound represented by the following formula:

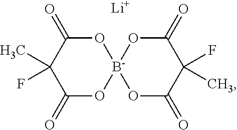 [SMILES: [Li+] ; CC1(F)C(=O)O[B-]2(OC1=O)OC(=O)C(C)(F)C(=O)O2]

and wherein the borate based additive is present in the range of 0.25 percent by weight to 5 percent by weight of the total weight of the electrolyte.

### BRIEF DESCRIPTION OF DRAWINGS

The drawings described herein are for illustration purposes only and are not intended to limit the scope of the present disclosure in any way.

FIG. 1 illustrates a vehicle and a power train including a secondary battery according to embodiments of the present disclosure.

FIG. 2A illustrates a battery according to embodiments of the present disclosure.

FIG. 2B illustrates a pouch or prismatic battery cell according to embodiments of the present disclosure.

FIG. 2C illustrates a cylindrical battery cell according to embodiments of the present disclosure.

FIG. 2D illustrates a coin battery cell according to embodiments of the present disclosure.

FIG. 3 illustrates a method of forming a battery cell including a borate based additive in the electrolyte according to embodiments of the present disclosure.

FIG. 4 illustrates the change in the percentage of capacity retention (vertical, y-axis) based on charge/discharge cycle number (horizontal, x-axis) for a 1 Amp-hour pouch cell including a polycrystalline lithium nickel cobalt manganese LiNi0.8Mn0.1Co0.1O2 (NMC811) cathode and an FEC/DMC/LiPF₆ electrolyte. The pouch cell included six layers of cathode and seven layers of anode.

FIG. 5 illustrates the change in the capacity in Amp-hours (vertical, y-axis) based on charge/discharge cycle number (horizontal, x-axis) for a 2 Amp-hour pouch cell including a polycrystalline lithium NCM 811 (nickel cobalt manganese) cathode and an FEC/DMC/LiPF₆/LiSI electrolyte.

FIG. 6 illustrates the change in the capacity in milliamp-hours (vertical, y-axis) based on charge/discharge cycle number (horizontal, x-axis) for a 1.6 Amp-hour pouch cell including a single crystal lithium NCM 613 (nickel cobalt manganese) cathode, 20 micrometer lithium anode, and an FEC/DMC/LiPF₆/LiSI electrolyte.

FIG. 7 illustrates the change in the specific capacity in milliamp-hours (vertical, y-axis) based on charge/discharge cycle number (horizontal, x-axis) for a coin cell including a single crystal lithium NCM 613 (nickel cobalt manganese) cathode, 30 micrometer lithium anode, and an FEC/DMC/LiPF₆ electrolyte with borate based additives.

FIG. 8 illustrates the change in the capacity in Amp-hours (vertical, y-axis) based on charge/discharge cycle number (horizontal, x-axis) for a 2 Amp-hours pouch cell including 12 layers of single crystal lithium NCM 613 (nickel cobalt manganese) cathode, and 13 layers of 20 micrometer lithium anode, and an FEC/DMC/LiPF₆/LiSI electrolyte compared to a an FEC/DMC/LiPF₆/LiDFOB electrolyte using the same cathode and anode.

FIG. 9 illustrates the change in the capacity in milliamp-hours (vertical, y-axis) based on charge/discharge cycle number (horizontal, x-axis) for a 1 Amp-hour pouch cell including six layers of polycrystalline lithium NCM 811 (nickel cobalt manganese) cathode, seven layers of 30 micrometer lithium anode, and an FEC/DMC/LiPF₆/LiSI electrolyte compared to a an FEC/DMC/LiPF₆/LiDFOB electrolyte using the same cathode and anode.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure is related to an electrolyte additive, an electrolyte for lithium metal batteries using a single crystal cathode, a battery cell for a vehicle including the electrolyte, and a battery for a vehicle including a battery cell as well as a method of forming the electrolyte. The electrolyte is used in combination with either a single crystal cathode or a polycrystalline cathode. The cathodes are incorporated into battery cells and secondary batteries, such as prismatic, pouch, cylindrical, or coin style battery cells. The batteries may then be used in electric or hybrid-electric vehicles.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as consumer electronics, power banks for buildings, and portable power stations used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

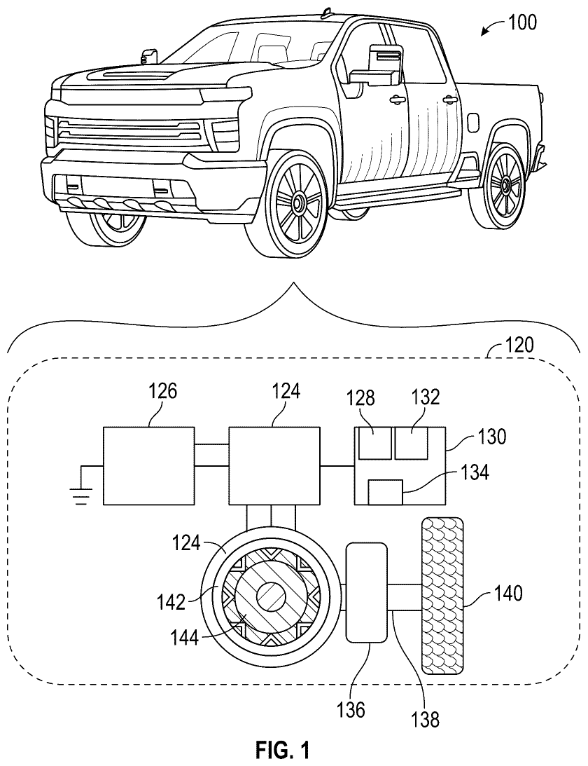

FIG. 1 illustrates a vehicle 100 including a propulsion system 120. The propulsion system 120 generally includes an electric motor 124 and a secondary battery 126 for powering the electric motor 124. Further, in many embodiments, the propulsion system 120 includes an inverter 128 for changing power from DC (direct current) as provided by the battery 126 to AC (alternating current) as it is used by the electric motor 124. The inverter 128 may be included in a power electronics module 130, which includes e.g., transistors and diodes, for switching the power from DC to AC and vice-versa.

A controller 132 is connected to the inverter 128 and is programmed to control and manage the operations of the electric motor 124 and associated hardware, including the inverter 128. The electric motor 124 is connected to a transmission (drive unit) 136, and drive line 138, which transfers mechanical power and rotation to the wheels 140 of the vehicle 100. The controller 132 includes one or more one or more processors and tangible, non-transitory memory 134. A combustible fuel powered engine may also be included in the propulsion system of hybrid-electric vehicles.

With reference again to the electric motor 124, the electric motor 124, powered by the battery 126, includes a stator 142 and a rotor 144 arranged within the stator 142. The stator 142 is the stationary part of the electric motor 124. The stator 142 provides a rotating magnetic field with which the stationary magnetic field of the rotor 144 tries to align with, causing the rotor 144 to rotate, in what may be referred to as “motoring” mode. In other applications the rotor's 144 rotating field (as caused by physical rotation) generates an electric current in the stator 142—this mode of operation is referred to as “generation” and the electric motor 124 used in this way is referred to as generator. In traction motor vehicle applications, the motoring mode provides motion to the vehicle 100. Generation mode takes some of the energy recovered from braking when the vehicle is in the process of stopping and stores it back in the vehicle battery 126.

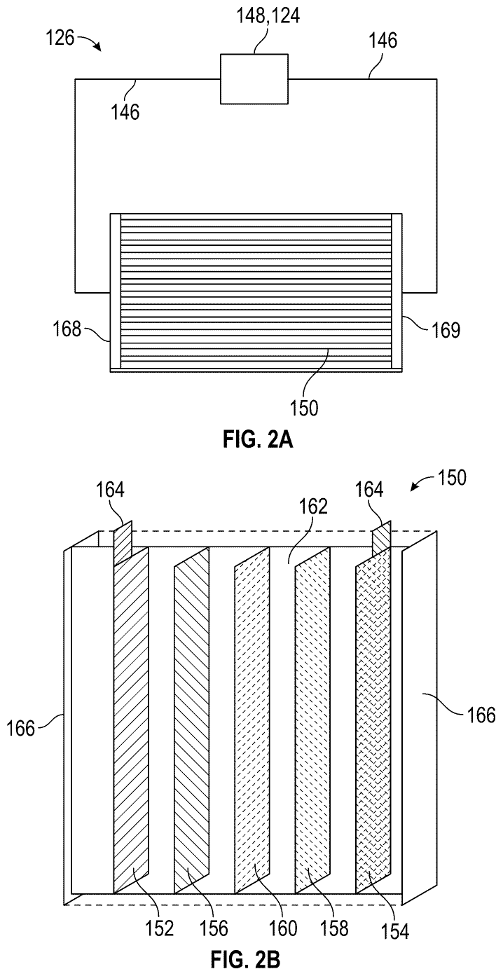

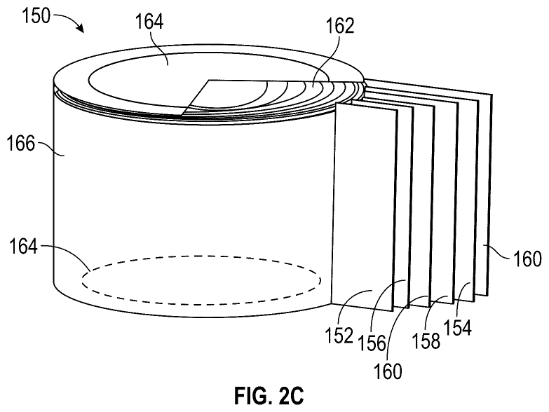

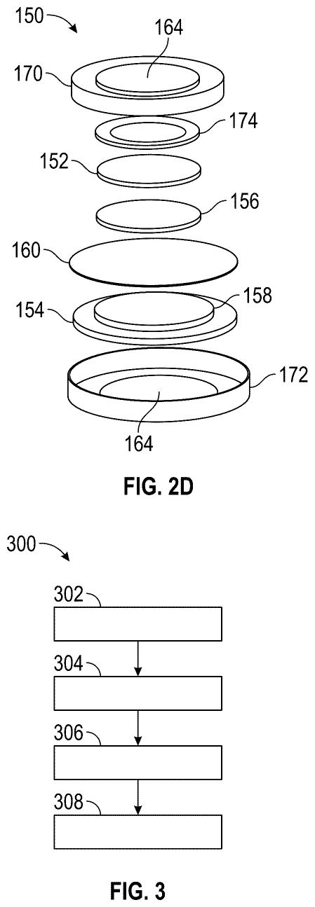

Reference is made to FIGS. 2A, 2B, 2C, and 2D illustrating an example of a secondary battery 126 for powering an electric vehicle 100, such as the electric vehicle 100 illustrated in FIG. 1. As noted above, secondary batteries 126 are understood as rechargeable batteries, that may be discharged upon application of a load and recharged upon the application of an external power source. Referring to FIG. 2A, 2B, 2C, and 2D, a battery 126 is illustrated as being connected to a load 148, such as the electric motor 124. However, other loads 148 include various systems in the vehicle 100 such as climate control systems and infotainment systems. The battery 126 includes one or more battery cells 150, that are assembled together. The battery cells 150 may be, for example, pouch style, prismatic, cylindrical, or coin discussed further below. With reference to FIGS. 2B through 2D, in particular, during discharge, when a load 148 is applied to the battery 126, Li+ ions move from the anode 158 to the cathode 156 through the separator 160 by way of the electrolyte 162. Equivalent electrons e-move through the circuitry 146 from the cathode 156 to the anode 158, providing voltage to the load 148. While charging, upon application of an external voltage, Li+ ions move from the cathode 156 to the anode 158 by way of the electrolyte 162 through the separator 160 and may be intercalated into the anode 158.

Each battery cell 150, such as those illustrated in FIGS. 2B, 2C, and 2D, generally includes a cathode current collector 152, a cathode 156 disposed on the cathode current collector 152, an anode current collector 154, an anode 158 disposed on the anode current collector 154, a separator 160 positioned between the cathode 156 and anode 158, and an electrolyte 162. While the illustrated battery cells 150 include one anode 158 (and anode current collector 154) and one cathode 156 (and one cathode current collector 152), the battery cell 150 may alternatively include two or more cathodes 156 (and one or more cathode current collectors 152) and one or more anodes 158 (and one or more anode current collectors 154). In further alternative embodiments, the battery cell 150 may include or one or more cathodes 156 (and one or more cathode current collectors 152) and two or more anodes 158 (and two or more anode current collectors 154). In any of the designs above, one or more separators 160 are interleaved between the cathodes 156 and anodes 158 to prevent the cathodes 156 and the anodes 158 from contacting.

In embodiments, the battery cell 150 of FIG. 2B is configured as a pouch style battery cell or in a prismatic battery cell. In either design, where multiple cathodes 156 and multiple anodes 158 are present, separators 160 are provided between the cathodes 156 and anodes 158. In embodiments, a ribbon shaped separator 160 may be z-folded around each cathode 156 (and cathode current collector 152) and around each anode 158 (and anode current collector 154). In a pouch style cell, tabs 164 are welded to the cathode current collectors 152 and the anode current collectors 154 and the covering 166 is in the form of a flexible film pouch formed of aluminum or another material. Prismatic style cells, on the other hand, include terminals that the cathode current collectors 152 and anode current collectors 154 are connected to and the covering 166 is formed of a relatively rigid casing, typically in the form of a cuboid. The tabs 164, or terminals, connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

Alternatively, the battery cell 150 of FIG. 2C is configured as a cylinder style battery cell 150. In this design, the cathode current collector 152, anode current collector 154, cathode 156, anode 158, and one or more separators 160 are in the form of long ribbons, which are rolled into a cylinder or jelly roll. Like the prismatic cell, the covering 166 is formed of a relatively rigid casing of aluminum or another material. Tabs 164 are welded to the cathode current collector 152 and anode current collector 154. The tabs 164 connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

In alternative embodiments, the battery cell 150 is packaged in a coin cell as illustrated in FIG. 2D. In this design, the cathode current collector 152, anode current collector 154, cathode 156, anode 158, and one or more separators 160 are in the form of discs, which are sandwiched together in the coin packaging forming the covering 166, which includes a cap 170 and a can 172. A spring washer 174 may be included between the cathode current collector 152 and the cap 170. Prior to securing the cap 170 on the can 172, electrolyte 162 is added to the battery cell 150. The cap includes terminals 164 for the anode 158 and cathode 156.

In the various styles of battery cells 150 noted above, the cathode current collector 152 and anode current collector 154 are formed from conductive materials. In embodiments, the cathode current collector 152 includes aluminum. Alternatively, or additionally, the cathode current collector 152 may include copper clad aluminum, and stainless steel. The anode current collector 154 includes one or more of copper, nickel, stainless steel, and titanium. The current collectors 152, 154 are illustrated as being in the form of a foil; however, it should be appreciated that other forms may be exhibited such as mesh. In embodiments, a foil cathode current collector 152 and a foil anode current collector 154 are impermeable to gas. The cathode current collector 152 exhibits a thickness in the range of 5 micrometers to 50 micrometers, including all values and ranges therein, such as in the range of 5 micrometers to 25 micrometers. The anode current collector 154 exhibits a thickness in the range of 4 micrometers to 50 micrometers, including all values and ranges therein, such as in the range of 4 micrometers to 25 micrometers.

The cathode 156 includes a source of lithium ions (Li⁺) and can undergo reversible insertion or intercalation of lithium ions, determining e.g., the capacity and average voltage of a battery. The cathode material includes, for example, lithium iron phosphate, lithium manganese iron phosphate, lithium cobalt oxide, lithium nickel manganese oxides, lithium nickel manganese cobalt oxides, lithium nickel cobalt aluminum oxides, and lithium nickel cobalt manganese aluminum oxide. In embodiments, the cathode material includes lithium nickel manganese cobalt oxides having the general formula LiNiₓMn_{y}Co_{1-x-y}O₂, wherein x is in the range of 0.1 to 0.95 including all values and ranges therein and y is in the range of 0.1 to 0.4, including all values and ranges therein. In further embodiments, the lithium nickel manganese cobalt oxides exhibit at least one of the following formulas: LiNi_{0.33}Mn_{0.33}Co_{0.33}O₂, LiNi_{0.5}Mn_{0.3}Co_{0.2}O₂, LiNi_{0.6}Mn_{0.2}Co_{0.2}O₂, LiNi_{0.6}Mn_{0.1}Co_{0.3}O₂ and LiNi_{0.8}Mn_{0.1}Co_{0.1}O₂. In preferred embodiments, the cathode includes at least one single crystal, wherein each single crystal is in the range of 5 percent by weight to 95 percent by weight of the total weight of the cathode 156 including all values and ranges therein and preferably in the range of 20 percent by weight to 50 percent by weight of the total weight of the cathode 156. It should be appreciated that a crystal is a solid material including atoms, molecules, or ions that are arranged in a generally repeating and ordered microscopic structure, although it should be appreciated that defects in the crystal may be present. A single crystal includes one ordered structure, which may be present in additional disordered or polycrystalline structures. Polycrystalline structures include multiple crystals, which may also be present with disordered structures. Disordered structures are generally considered amorphous exhibiting little to no order. In embodiments, the single crystal cathode is nickel rich, that is, the single crystal cathode includes LiNiₐMn_{b}Co_{c}AL_{d}O₂, wherein the sum of a, b, c and d is 1.

The cathode 156 exhibits a thickness in the range of 80 micrometers to 500 micrometers, including all values and ranges therein, such as 110 micrometers. The cathode electrode, including both the cathode current collector 152 and the cathode 156, exhibits a thickness in the range of 85 micrometers to 550 micrometers including all values and ranges therein when the cathode material is formed on one side of the cathode current collector 152. When the cathode material is formed on both sides of the cathode current collector 152, the cathode electrode exhibits a thickness in the range of 165 micrometers to 1050 micrometers including all values and ranges therein for a double sided cathode electrode, such as in the range of 205 micrometers to 500 micrometers.

The anode 158 includes materials that can undergo reversible insertion or intercalation of lithium ions at a lower electrochemical potential than the cathode 156 material, such that an electrochemical potential difference exists between the anode 158 and cathode 156. The anode material may include one or more of lithium metal; alloys of lithium such as lithium silicon alloy, lithium aluminum alloy, lithium indium alloy, lithium titanate, and lithium tin alloy; carbon based materials such as graphite, activated carbon, carbon black and graphene; silicon; silicon based alloys; silicon oxide; silicon based composite materials; tin oxide; aluminum; indium; zinc; germanium; and titanium oxide; as well as any combination of the above. In embodiments, the anode 158 exhibits a thickness in the range of 10 micrometers to 550 micrometers, including all values and ranges therein. In embodiments, the anode 158 is applied to the anode current collector 154, forming a coating on the anode current collector 154, using a deposition process, such as a slurry based process, hot roll pressing process, extrusion or additive manufacturing. The combined anode 158 and anode current collector 154 provide an anode electrode, as referenced further herein.

The separator 160 is a porous material formed of an electrically insulative material that prevents the cathode 156 and anode 158 from contacting and potentially shortening out the circuit. The separator 160 is sandwiched, or at least partially enclosed, between the cathode 156 and anode 158, allowing the passage of the lithium ions and electrolyte 162 through the pores of the separator 160. The separator 160 may include one or more of a composite, a polymeric material, and a non-woven material. In embodiments, the separator includes at least one of polyethylene, polypropylene, polyamide, polytetrafluoroethylene, polyvinylidene fluoride, and polyvinyl chloride. In addition, the separator 160 may be filled, i.e., include one or more fillers dispersed therein, wherein the one or more fillers includes materials such as glass fiber, nonwoven fabrics, or woven fabrics. In additional or alternative embodiments, the separator 160 may include at least one of a thermally stable, porous polymer coating and a ceramic coating such as an alumina coating. The coating is disposed on one or more surfaces of a porous polymer film, the polymer film being selected from at least one of polyethylene and polypropylene. The separator 160 may include one or more layers, wherein each layer is formed from one or more of the materials noted above. The separator 160 may take the form of film or a mesh, such as woven mesh or a slit film. In embodiments, the separator 160 exhibits a thickness in the range of 4 micrometers to 25 micrometers, including all values and ranges therein.

The electrolyte 162 provides a medium between the cathode 156 and anode 158 through which lithium ions travel. The medium may be a liquid, gel, or solid, and capable of conducting the lithium ions between the cathode 156 and the anode 158. Liquid and gel electrolytes 162 permeates the pores of the porous separator 160 and wet, or otherwise contact, the surfaces of the cathode 156 and anode 158 as well as the separator 160. In embodiments, the electrolyte 162 includes one or more lithium salts dissolved in non-aqueous organic solvent. The lithium salts may include one or more of the following: lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and lithium bis(trifluoromethanesulfonyl)azanide (LiTFSA). The lithium salt may be present in the electrolyte 162 at a concentration (moles of salt per liter of solvent) ranging from 1 M to 4 M, including all values and ranges therein, such as 1 M to 3 M.

In embodiments, the lithium salt includes a combination of lithium bis(fluorosulfonyl)imide and lithium hexafluorophosphate, wherein the lithium bis(fluorosulfonyl)imide is present in the range of 0.1 M to 1 M, including all values and ranges therein, and the lithium hexafluorophosphate is present in the range of 0.1 M to 1 M, including all values and ranges therein, and in particular embodiments, the combination of the lithium bis(fluorosulfonyl)imide and lithium hexafluorophosphate is present at 1.2 M in the electrolyte 162. In alternative embodiments, the lithium electrolyte includes a combination of lithium bis(fluorosulfonyl)imide and lithium hexafluorophosphate, wherein the lithium bis(fluorosulfonyl)imide is present in the range of 0.1 M to 1 M, including all values and ranges therein, and the lithium hexafluorophosphate is present in the range of 0.1 M to 1 M, including all values and ranges therein, and in particular embodiments, the combination of the lithium difluorooxalatoborate and lithium hexafluorophosphate is present at 1.2 M in the electrolyte 162.

In embodiments, the non-aqueous organic solvent includes or more of various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), linear chain ethers (e.g., 1,2-dimethoxyethane, 1-2-diethoxyethane, ethoxymethoxy ethane), and cyclic ethers (e.g., tetrahydrofuran, 2-methyltetrahydrofuran, 1,3-dioxolane). The non-aqueous organic solvent exhibits the following formula CₓH_{y}F_{w}O_{z}, wherein x is in the range of 3 to 6, y is in the range of 3 to 14, w is one of 0 and 1, and z is in the range of 1 to 3, including all values and ranges within the ranges. Further the non-aqueous organic solvent exhibits a molar mass in the range of 60 grams per mole to 120 grams per mole, including all values and ranges therein.

In embodiments, the non-aqueous organic solvent includes a combination of fluoroethylene carbonate and dimethyl carbonate, wherein the fluoroethylene carbonate is present in the range of 10 percent by weight to 90 percent by weight of the total weight of the solvent, including all values and ranges therein and preferably 50 percent by weight, and the dimethyl carbonate is present in the range of 10 percent by weight to 90 percent by weight of the total weight of the solvent, including all values and ranges therein and preferably 50 percent by weight.

In addition, the electrolyte 162 includes one or more borate based additives. In embodiments, the additive includes one or more of the following borate based lithium salts: a compound represented by the following formula: Li[B(OCH₂)ₓ(CF₃)₄], wherein x is in the range of 1 to 6, including all values therein, such as the compound represented by the following chemical structure:

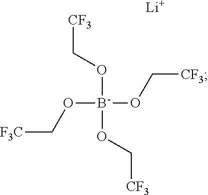 [SMILES: [Li+] ; FC(F)(F)CO[B-](OCC(F)(F)F)(OCC(F)(F)F)OCC(F)(F)F]

lithium bis(oxalato)borate (LiB(C₂O₄)₂) (LiBOB) represented by the following chemical structure:

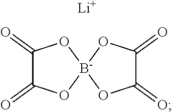 [SMILES: [Li+] ; O=C1O[B-]2(OC1=O)OC(=O)C(=O)O2]

lithium difluorooxalatoborate (LiBF₂(C₂O₄)) (LiODFB) represented by the following chemical structure:

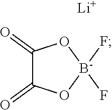

and the compound represented by the following structure:

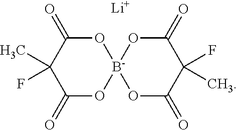 [SMILES: [Li+] ; CC1(F)C(=O)O[B-]2(OC1=O)OC(=O)C(C)(F)C(=O)O2]

In additional or alternative embodiments, the borate based additives includes one or more of the following compositions: trimethyl borate, tris(trimethyl silyl borate), triethyl borate, tris(2,2,2-trifluorethyl)borate, triisopropyl borate, tris(2-cyanoethyl)borate, triphenyl borate.

The borate based additives are present in the range of 0.25 percent by weight to 5 percent by weight of the total weight of the electrolyte, including all values and ranges therein, and preferably from 0.5 percent by weight to 1 percent by weight of the total weight of the electrolyte. The borate based additives preferentially oxidize over the electrolyte solvent and decompose to create a protective film on the cathode surface. In addition, the borate based additives exhibit a relatively strong surface absorption energy relative to the electrolyte solvents as well as sulfate, sulfite, phosphate and phosphite lithium salts suppressing side reactions and stabilizing the microstructure of the electrode.

Further, the electrolyte 162 may include a number of additional additives, such as, but not limited to vinyl carbonate, vinyl-ethylene carbonate, propane sulfonate, 1,3,2-dioxathiolane 2,2-dioxide (DTD), LiPF₂O₂, and combinations thereof. Additional additives can also include diluents which do not coordinate with lithium ions but can reduce viscosity of the electrolyte 162 such as bis(2,2,2-trifluoroethyl) ether (BTFE), and flame retardants such as triethyl phosphate.

The electrolyte 162 is formed by mixing the non-aqueous organic solvent, the lithium salt, and the borate based additive, along with any additional additives that may be present. The electrolyte 162 may then be added to a battery cell, including any one of the battery cells 150 illustrated in FIGS. 2B through 2D. FIG. 3 illustrates an embodiment of a method 300 of forming a battery cell 150 including the electrolyte 162 include a borate based additive. At block 302, the cathode current collector 152, anode current collector 154, cathode 156, anode 158, and separator 160 are assembled in a battery cell 150 covering 166. In embodiments, the cathode 156 is deposited onto the cathode current collector 152 prior to battery cell assembly 150 and the anode 158 is deposited onto the anode current collector 154 prior to battery cell assembly 150. At block 304, the electrolyte 162 including the borate based additive is added to the battery cell 150. At block 306 the battery cell 150 is sealed. In further embodiments, at block 308 the battery cell 150 is coupled to additional battery cells 150 to form a battery 126 for use in a vehicle 100 or other application.

Single crystal cathode battery cells produced herein are capable of reaching approximately 270 cycles to 350 cycles before a drop in battery capacity is observed. Further, the electrolytes herein were not found to negatively impact the cycle life observed in polycrystalline cathodes, reaching approximately 550 cycles before testing was ended.

### Comparative Examples

In the examples described herein 2032 type coin cells were used for battery testing. Li∥NMC cells were assembled in an argon-filled glovebox with Li metal foil on a copper current collector as both the counter and reference electrodes. Al₂O₃ filled microporous polyethylene (PE), was used as a separator. The effective diameters of cathode, anode, and separator were 14 millimeters, 15 millimeters, and 16 millimeters, respectively. The electrolyte injection amount was 30 microliters.

Further, in the examples described herein pouch cells were fabricated with a LiNi_{0.8}Mn_{0.1}Co_{0.1}O₂ (NMC 811) cathode, a lithium anode with 20 or 30 micrometers of Li metal foil on an 8 micrometer copper foil current collector. Al₂O₃ filled microporous polyethylene (PE) was used as the separator. The liquid electrolyte was prepared in-house as described above. Pouch cells were constructed using a 6.0 centimeter by 5.0 centimeter punched cathode electrode and a 6.2 centimeter by 5.2 centimeter punched lithium anode, and a 6.5 centimeter wide separator. The anode was larger than the cathode to ensure full cathode coverage. Twenty-seven pieces of cathode and twenty-eight pieces of anode were stacked to assemble the pouch cell in a dry room (−40 degrees Celsius dew point).

Electrochemical experiments were conducted on a Landt cycler (model#CT3001A) at 25° C. A relatively low stack pressure of 103.4 kilopascals (15 pounds per square inch (psi)) was applied uniformly on the cell during testing. Cells were first cycled at 100 milliAmp (mA) or 200 (mA) using a ten hour charge (C/10) and a ten hour discharge (C/10) for both charge and discharge between 3.0 Volts to 4.25 Volts for 2 formation cycles. After that, the cell was removed from the fixture for degassing and final sealing/trimming. The cell was then put back into the fixture with 103.4 kilopascals pressure for cycling. The charge phase of each cycle was constant-current charge at 100 mA or 200 mA using a ten hour charge (C/10) to 4.25 Volts followed by a constant-voltage hold at 4.25 Volts, terminating at 20 mA. The discharge phase was a constant-current 500 mA or 1 Amp (A) at a 2 hour discharge to 3.0 Volts, with no voltage hold. After each charge and discharge cycle, the cell was rested at open circuit for 10 minutes before the next cycle. The voltage and current were sampled at a maximum time interval of 30 seconds or a voltage change of 1 mV, whichever came first.

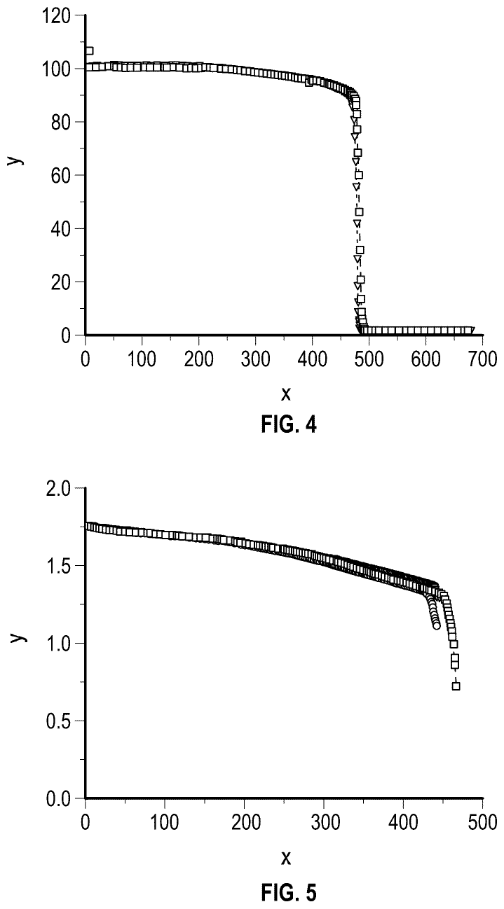

FIG. 4 illustrates the change in the percentage of capacity retention (vertical axis) based on charge/discharge cycle number (horizontal axis) for two 1 Amp-hour pouch cells, each including six layers of polycrystalline lithium nickel cobalt manganese LiNi_{0.8}Mn_{0.1}Co_{0.1}O₂ (NMC811) cathode, seven layers of a lithium anode, and an FEC/DMC/LiPF₆ electrolyte including a combination of fluoroethylene carbonate present at 1 part by volume and dimethyl carbonate present at 4 parts by volume as the solvent and lithium hexafluorophosphate as the salt present at 1.2 M. The charge and discharge rates were 10 hour (C/10) charge and 2 hour (C/2) discharge. As can be seen in the figure, the capacity retention drops off around 500 cycles.

FIG. 5 illustrates the change in the capacity in Amp-hours (vertical axis) based on charge/discharge cycle number (horizontal axis) for a three 2 Amp-hour pouch cells, each including a polycrystalline lithium NCM 811 (LiNi_{0.8}Mn_{0.1}Co_{0.1}O₂) cathode and an FEC/DMC/LiPF₆/LiFSI electrolyte including a combination of fluoroethylene carbonate and dimethyl carbonate as the solvent and a combination of lithium hexafluorophosphate and lithium bis(fluorosulfonyl)imide as the salt. The charge and discharge rates were 10 hour (C/10) charge and 2 hour (C/2) discharge. The cells failed after about 470 cycles and exhibited a capacity retention of approximately 75 percent.

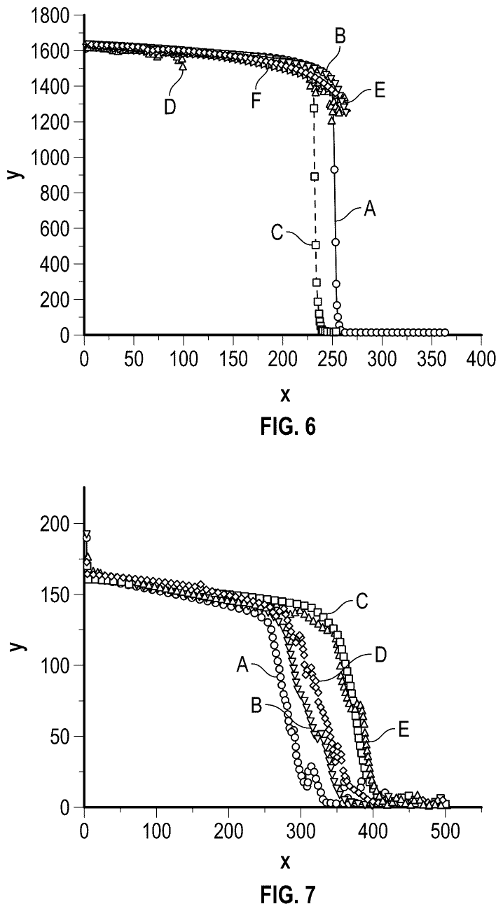

FIG. 6 illustrates the change in the capacity in Amp-hours (vertical axis) based on charge/discharge cycle number (horizontal axis) for six 1.6 Amp-hour pouch cells, each including a single crystal lithium NCM 613 (LiNi_{0.6}Mn_{0.1}Co_{0.3}O₂) cathode, 20 micrometer lithium anode, and an FEC/DMC/LiPF₆/LiSI electrolyte including a combination of fluoroethylene carbonate present at 1 part by volume and dimethyl carbonate present at 4 parts by volume as the solvent and a combination of lithium hexafluorophosphate present at 1.0 M and lithium bis(fluorosulfonyl)imide present at 0.2 M as the salt. Three of the of the pouch cells included electrolyte present at 3.6 grams (A, B, C) and three of the of the pouch cells included electrolyte present at 4.2 grams (D, E, F). The charge and discharge rates were charge and discharge rates were 10 hour (C/10) charge and 2 hour (C/2) discharge. The battery capacity significantly decreased or failed at approximately 250 cycles. As can be seen, the single crystal pouch cells exhibited relatively lower retention of capacity as compared to the polycrystalline pouch cells.

FIG. 7 compares the change in the specific capacity in milliamp-hours (vertical axis) based on charge/discharge cycle number (horizontal axis) for five 2032 coin cells including a single crystal lithium NCM 613 (LiNi_{0.6}Mn_{0.1}Co_{0.3}O₂) cathode, 30 micrometer lithium anode, and an FEC/DMC/LiPF₆ electrolyte including a combination of fluoroethylene carbonate present at 1 part by volume and dimethyl carbonate present at 4 parts by volume as the solvent and lithium hexafluorophosphate present at 1.2 M as the salt as a baseline electrolyte (A) without the borate based additive, an electrolyte including trimethyl borate (B), an electrolyte including trimethylsilyl borate (TMSiB) (C), an electrolyte including lithium bis(oxalato)borate (D), and an electrolyte including lithium difluorooxalatoborate (LiBF₂(C₂O₄)) (E), the additives being present at 0.5% by weight of the total weight of the electrolytes. The charge and discharge rates were 10 hour (C/10) charge and 2 hour (C/2) discharge. As can be seen, the borate based additives improved the specific capacity of the battery cells.

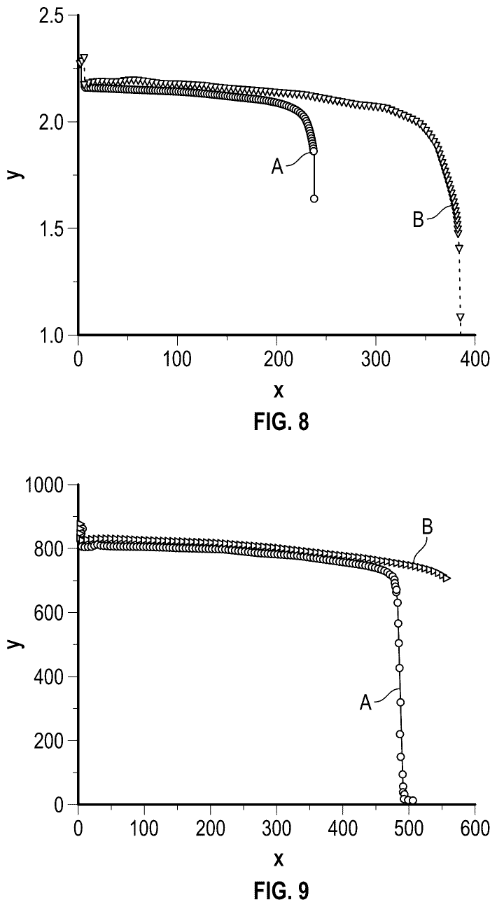

FIG. 8 illustrates the change in the capacity in Amp-hours (vertical axis) based on charge/discharge cycle number (horizontal axis) for two 1 Amp-hour pouch cells, including six single crystal lithium NCM 613 (LiNi_{0.6}Mn_{0.1}Co_{0.3}O₂) cathode layers and seven 20 micrometer lithium anode layers. One cell included FEC/DMC/LiPF₆/LiFSI electrolyte including a combination of fluoroethylene carbonate present at 1 part volume and dimethyl carbonate present at 4 parts volume as the solvent and a combination of lithium hexafluorophosphate present at 1.0 M and lithium bis(fluorosulfonyl)imide present at 0.2 M as the salt (A) and one cell included FEC/DMC/LiPF₆/LiDFOB electrolyte including a combination of fluoroethylene carbonate present at 1 part volume and dimethyl carbonate present at 4 parts volume as the solvent and a combination of lithium hexafluorophosphate present at 1.2 M and lithium difluorooxalatoborate present at 0.5 weight percent of the electrolyte as the salt (B). The charge and discharge rates were 10 hour (C/10) charge and 2 hour (C/2) discharge. As can be seen, the inclusion of the borate based additive in the electrolyte improved the capacity retention of the battery cell.

FIG. 9 illustrates the change in the capacity in milliamp-hours (vertical axis) based on charge/discharge cycle number (horizontal axis) for two pouch cells, each 2 amp-hours including a polycrystalline lithium NCM 811 (LiNi_{0.8}Mn_{0.1}Co_{0.1}O₂) cathode and 30 micrometer lithium anode. One cell included FEC/DMC/LiPF₆/LiSI electrolyte including a combination of fluoroethylene carbonate present at 1 part volume and dimethyl carbonate present at 4 parts volume as the solvent and a combination of lithium hexafluorophosphate present at 1.0 M and lithium bis(fluorosulfonyl)imide present at 0.2 M as the salt (A) and one cell included FEC/DMC/LiPF₆/LiDFOB electrolyte including a combination of fluoroethylene carbonate present at 1 part volume and dimethyl carbonate present at 4 parts volume as the solvent and a combination of lithium hexafluorophosphate present at 1.0 M and lithium difluorooxalatoborate present at 0.5 percent by weight of the total weight of the electrolyte as the salt (B). The charge and discharge rates were 10 hour (C/10) charge and 2 hour (C/2) discharge. As can be seen, the inclusion of the borate based additive in the electrolyte did not affect the performance of the cells including the polycrystalline cathode.

The electrolytes, battery cells, secondary batteries, and methods of making described herein offer a number of advantages. These advantages include, for example, the enablement of the use of single crystal cathodes. These advantages also include forming an interface with single crystal cathodes that exhibit conductivities that are relatively higher than electrolytes without the additives. These advantages additionally include a reduction in impedance build up. These advantages further include an improvement in single crystal cathode battery cyclability and improved thermal stability. In addition, these advantages include the ability to use the electrolyte including the additives with polycrystalline cathodes without exhibiting a decrease in performance.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 132 may also consist of multiple controllers which are in electrical communication with each other. The controller 132 may be inter-connected with additional systems and/or controllers of the vehicle 100, allowing the controller 132 to access data such as, for example, speed, acceleration, braking, and steering angle of the vehicle 100.

A processor may be a custom made or commercially available processor, a central processing unit (CPU), a graphics processing unit (GPU), an auxiliary processor among several processors associated with the controller 132, a semi composite conductor-based microprocessor (in the form of a microchip or chip set), a macroprocessor, a combination thereof, or generally a device for executing instructions.

The tangible, non-transitory memory 134 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 134 may be implemented using a number of memory devices such as PROMs (programmable read-only memory), EPROMS (electrically PROM), EEPROMs (electrically erasable PROM), flash memory, or another electric, magnetic, optical, or combination memory devices capable of storing data, some of which represent executable instructions, used by the controller 132 to control various systems of the vehicle 100.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An electrolyte for a battery cell, the electrolyte comprising:
a non-aqueous organic solvent including one or more solvents selected from the group consisting of a cyclic carbonate, a linear carbonate, an aliphatic carboxylic ester, a linear chain ester, and a cyclic ether;
a lithium salt, wherein the lithium salt is present in the non-aqueous organic solvent in the range of 1 M to 4 M; and
a borate based additive, wherein the borate based additive includes at least one compound selected from the group consisting of: trimethyl borate, tris(trimethyl silyl borate), triethyl borate, tris(2,2,2-trifluorethyl)borate, triisopropyl borate, tris(2-cyanoethyl)borate, triphenyl borate, Li[B(OCH₂)ₓ(CF₃)₄] wherein x is in the range of 1 to 6, lithium bis(oxalato)borate, lithium difluorooxalatoborate, and a compound represented by the following formula: 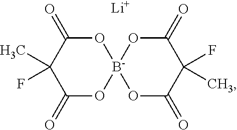 [SMILES: [Li+] ; CC1(F)C(=O)O[B-]2(OC1=O)OC(=O)C(C)(F)C(=O)O2]
and the borate based additive is present in the range of 0.25 percent by weight to 5 percent by weight of the total weight of the electrolyte.

2. The electrolyte of claim 1, wherein the non-aqueous organic solvent exhibits the following formula CₓH_{y}F_{w}O₂, wherein x is in the range of 3 to 6, y is in the range of 3 to 14, w is one of 0 and 1, and z is in the range of 1 to 3 and exhibits a molar mass in the range of 60 grams per mole to 120 grams per mole.

3. The electrolyte of claim 2, wherein the non-aqueous organic solvent includes one or more solvents selected from the group consisting of: ethylene carbonate (EC), propylene carbonate (PC), butylene carbonate (BC), fluoroethylene carbonate (FEC), dimethyl carbonate (DMC), diethyl carbonate (DEC), ethylmethylcarbonate (EMC), methyl formate, methyl acetate, methyl propionate, γ-butyrolactone, γ-valerolactone, 1,2-dimethoxyethane, 1-2-diethoxyethane, ethoxymethoxy ethane, tetrahydrofuran, 2-methyltetrahydrofuran, and 1,3-dioxolane.

4. The electrolyte of claim 1, wherein the lithium salt includes one or more lithium salts selected from the group consisting of: lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and lithium bis(trifluoromethanesulfonyl)azanide (LiTFSA).

5. The electrolyte of claim 1, wherein the non-aqueous organic solvent includes fluoroethylene carbonate and dimethyl carbonate, wherein the fluoroethylene carbonate is present in the range of 10 percent by weight to 90 percent by weight of the total weight of the non-aqueous organic solvent and the dimethyl carbonate is present in the range of 10 percent by weight to 90 percent by weight of the total weight of the non-aqueous organic solvent.

6. The electrolyte of claim 5, wherein the lithium salt includes one or more of lithium hexafluorophosphate and lithium bis(fluorosulfonyl)imide.

7. The electrolyte of claim 6, wherein the borate based additive is Li[B(OCH₂)ₓ(CF₃)₄] wherein x is in the range of 1 to 6.

8. The electrolyte of claim 6, wherein the borate based additive is lithium bis(oxalato)borate.

9. The electrolyte of claim 6, wherein the borate based additive is lithium difluorooxalatoborate.

10. The electrolyte of claim 6, wherein the borate based additive is a compound represented by the following formula:

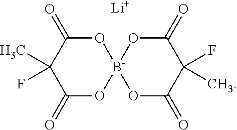 [SMILES: [Li+] ; CC1(F)C(=O)O[B-]2(OC1=O)OC(=O)C(C)(F)C(=O)O2]

11. A battery cell for use in a vehicle battery, comprising:
a cathode disposed on a cathode current collector;
an anode disposed on an anode current collector;
a separator positioned between the cathode and the anode; and
an electrolyte contacting the cathode, anode, and separator, wherein the electrolyte includes:
a non-aqueous organic solvent including one or more solvents selected from the group consisting of a cyclic carbonate, a linear carbonate, an aliphatic carboxylic ester, a linear chain ester, and a cyclic ether,
a lithium salt, wherein the lithium salt is present in the non-aqueous organic solvent in the range of 1 M to 4 M; and
a borate based additive, wherein the borate based additive includes at least one compound selected from the group consisting of: trimethyl borate, tris(trimethyl silyl borate), triethyl borate, tris(2,2,2-trifluorethyl)borate, triisopropyl borate, tris(2-cyanoethyl)borate, triphenyl borate, Li[B(OCH₂)ₓ(CF₃)₄] wherein x is in the range of 1 to 6, lithium bis(oxalato)borate, lithium difluorooxalatoborate, and a compound represented by the following formula: 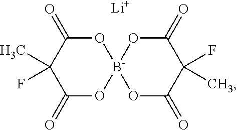 [SMILES: [Li+] ; CC1(F)C(=O)O[B-]2(OC1=O)OC(=O)C(C)(F)C(=O)O2]
and the borate based additive is present in the range of 0.25 percent by weight to 5 percent by weight of the total weight of the electrolyte.

12. The battery cell of claim 11, wherein the anode includes one or more materials selected from the group consisting of: lithium silicon alloy, lithium aluminum alloy, lithium indium alloy, lithium titanate, lithium tin alloy, graphite, activated carbon, carbon black, graphene, silicon, silicon based alloys, silicon oxide, silicon based composite materials, tin oxide, aluminum, indium, zinc, germanium, and titanium oxide.

13. The battery cell of claim 11, wherein the cathode includes at least one material selected from the group consisting of: lithium iron phosphate, lithium manganese iron phosphate, lithium cobalt oxide, lithium nickel manganese oxides, lithium nickel manganese cobalt oxides, lithium nickel cobalt aluminum oxides, and lithium nickel cobalt manganese aluminum oxide.

14. The battery cell of claim 13, wherein the cathode includes lithium nickel manganese cobalt oxides having the formula LiNiₐMn_{b}Co_{c}AL_{d}O2, wherein the sum of a, b, c, and d is 1.

15. The battery cell of claim 13, wherein the cathode includes one or more single crystals, wherein each single crystal is in the range of 5 percent by weight to 95 percent by weight of the total weight of the cathode.

16. The battery cell of claim 15, wherein each single crystal is in the range of 20 percent by weight to 50 percent by weight of the total weight of the cathode.

17. The battery cell of claim 15, wherein the anode includes lithium.

18. The battery cell of claim 17, wherein the non-aqueous organic solvent includes fluoroethylene carbonate and dimethyl carbonate, wherein the fluoroethylene carbonate is present in the range of 10 percent by weight to 90 percent by weight of the total weight of the non-aqueous organic solvent and the dimethyl carbonate is present in the range of 10 percent by weight to 90 percent by weight of the total weight of the non-aqueous organic solvent, and wherein the lithium salt includes one or more of lithium hexafluorophosphate and lithium bis(fluorosulfonyl)imide.

19. The battery cell of claim 18, wherein the borate based additive, wherein the borate based additive includes at least one compound selected from the following group of compounds: Li[B(OCH₂)ₓ(CF₃)₄] wherein x is in the range of 1 to 6, lithium bis(oxalato)borate, lithium difluorooxalatoborate, and a compound represented by the following formula:

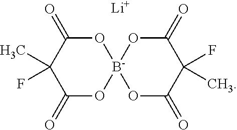 [SMILES: [Li+] ; CC1(F)C(=O)O[B-]2(OC1=O)OC(=O)C(C)(F)C(=O)O2]

20. A method of forming an electrolyte, comprising:
mixing a non-aqueous organic solvent, a lithium salt, and a borate based additive, wherein the non-aqueous organic solvent includes one or more non-aqueous organic solvents selected from the group consisting of a cyclic carbonate, a linear carbonate, an aliphatic carboxylic ester, a linear chain ester, and a cyclic ether, wherein the lithium salt is present in the non-aqueous organic solvent in the range of 1 M to 4 M, wherein the borate based additive includes at least one compound selected from the following group of compounds: trimethyl borate, tris(trimethyl silyl borate), triethyl borate, tris(2,2,2-trifluorethyl)borate, triisopropyl borate, tris(2-cyanoethyl)borate, triphenyl borate, Li[B(OCH₂)ₓ(CF₃)₄] wherein x is in the range of 1 to 6, lithium bis(oxalato)borate, lithium difluorooxalatoborate, and a compound represented by the following formula: 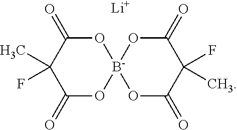 [SMILES: [Li+] ; CC1(F)C(=O)O[B-]2(OC1=O)OC(=O)C(C)(F)C(=O)O2]
and wherein the borate based additive is present in the range of 0.25 percent by weight to 5 percent by weight of the total weight of the electrolyte.
